(19) United States
(12) Patent Application Publication
(10) Pub. No.: US 2021/0338518 A1
(43) Pub. Date: Nov. 4, 2021

(54) THERMAL TRANSFER MASSAGER AND A TRANSFER REPLACEMENT STRUCTURE THEREOF

(71) Applicant: Chun-Ming YU, Taoyuan City (TW)

(72) Inventors: Chun-Ming YU, Taoyuan City (TW); Shih-Ming HUANG, Taipei City (TW)

(21) Appl. No.: 16/917,378

(22) Filed: Jun. 30, 2020

(30) Foreign Application Priority Data
Apr. 29, 2020 (TW) 109205135

(51) Int. Cl. A61H 7/00; A61H 15/00

(52) U.S. Cl. CPC A61H 7/003; A61H 15/0092; A61H 2201/0111; A61H 2201/0153; A61H 2201/0157; A61H 2201/1692; A61H 2201/0242; A61H 2201/0264; A61H 2201/1654; A61H 2201/1671; A61H 2201/0207

(57) ABSTRACT

The present invention discloses a thermal transfer massager and a transfer replacement structure thereof. The massager performs a thermal therapy to tendons and includes a spherical main body which is held by a palm for operation. The heat mass stored in the main body is released directionally, and an opening for the access of thermal transfer substance is blocked effectively by a sealing cap with radial thermal expansion effect. At the orientation in which the main body is used, the main body can be replaced at a three-dimensional angular position. In addition, by the symmetry of an outer curve, a provided heat-resistant sheath unit is replaceably covered on two axial ends of the main body to change the flow of heat balance, thereby achieving a multifunctional massaging effect.

### BACKGROUND OF THE INVENTION

### a) Field of the Invention

The present invention relates to a thermal transfer massager and a transfer replacement structure thereof, and more particularly to a massager for thermal massaging wherein an opening can be blocked effectively, as well as a multi-functional replacement structure of that massager.

### b) Description of the Prior Art

When a person suffers from the obstruction of vital energy and blood, the capillaries can be invigorated by doing massage or naprapathy to the skin, so that the blood circulation can be accelerated for palliation and even a positive physical therapy effect can be obtained. In the process of doing the naprapathy, if a heat radiation wave is guided into the skin texture, then the cells can be activated effectively and the blood circuit can be conducted rapidly. To operate the massaging, one can employ another person's palms for doing the naprapathy, or can utilize many kinds of electromechanical apparatuses as an assistance. Furthermore, to facilitate a random use, a massage stick or massage ball is often used to implement push and massage. For those kinds of tools held by the palms, if a heat wave can be guided in, then the massage and naprapathy will form an enhanced effect of physical therapy.

In a Taiwanese Patent No. 092201840, “Heat Wave Scraper for a Febrile Disease,” an interior of a cup-shaped handle body is provided with an isothermal heater, and the resulted heat wave is emitted upward through a scrape opening, which forms a thermal action to excite blood vessels inside the skin. On the other hand, in a Taiwanese Patent No. 095209809, “Spaced Scraper for a Febrile Disease,” a row of scrape teeth is disposed on the scrape opening, and an interior of the scraper is also provided with an electric heating element to transmit the resulted heat to the scrape opening. Finally, in a Taiwanese Patent No. 098209994, “Thermal Massager,” an interior of a pressable ceramic head is provided with an electric heating structure, and the heat generated from a provided heating flake is guided to the massaging ceramic head through a diffuser plate. All of the abovementioned heat sources are generated by thermoelectric conversion, and their common object is to emit the heat radiation wave to act onto the human skin. However, all of them will need to connect to an electric wire.

### SUMMARY OF THE INVENTION

A primary object of the present invention is to disclose a thermal transfer massager and a transfer replacement structure thereof. The present invention is a massager to be held for operation, comprising a shell-like spherical main body having a longitudinal axis. An end of the main body is an opening end, and is coaxially connected to an opening. The opening is covered by a sealing cap with the thermal expansion effect, so that the liquid thermal transfer substance can be prevented from seepage when the main body is at any operating angle in operating massage.

A second object of the present invention is to disclose a thermal transfer massager and a transfer replacement structure thereof, wherein by the effective sealing with the sealing cap, when the main body is being used, it can be put upside down for replacement at any angle. The massager is also provided with a sheath unit which is symmetric to an outer curve on two axial ends of the main body. The sheath unit can be covered replaceably depending on the demand for use to change the flow direction of heat balance.

A third object of the present invention is to disclose a thermal transfer massager and a transfer replacement structure thereof. The main body is coaxially provided with a protruded annular scrape opening on an end opposite a point-pressing end against the axis, which provides for scraping accretion in tendons to increase the massaging function.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a side view of assembly of a thermal massager, according to the present invention.

FIG. 2 shows a perspective view of combination of a sheath unit with a main body of the thermal massager, according to the present invention.

FIG. 3 shows side view of a sealing cap of the present invention.

FIG. 4 shows a cutaway view of an application state of the present invention.

FIG. 5 shows a schematic view that the thermal massager is subjected to action forces at various directions in massaging, according to the present invention.

FIG. 6 shows a schematic view that the thermal massager is provided with a belly, according to the present invention.

FIG. 7 shows a schematic view of replacing the sheath unit of the present invention.

FIG. 8 shows a schematic view that the main body is exposed out of an annular scrape opening, according to the present invention.

FIG. 9 shows a schematic view that the thermal massager is provided with a waist, according to the present invention.

FIG. 10 shows another schematic view of replacing the sheath unit of the present invention.

FIG. 11 shows a schematic view that the main body is provided with annular bumps, according to the present invention.

### DETAILED DESCRIPTION OF THE PREFERRED EMBODIMENTS

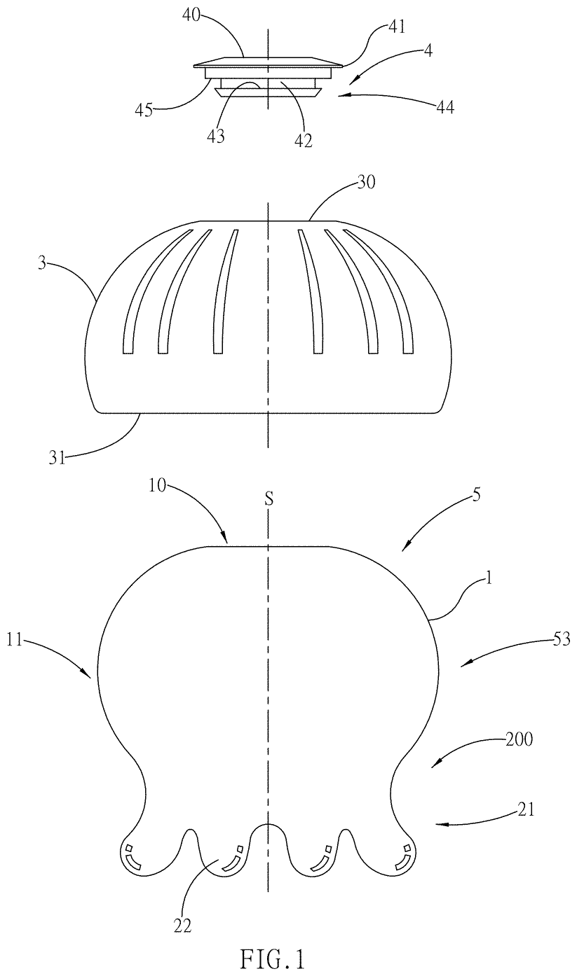

Referring to FIG. 1, the present invention provides a thermal massager 5. An interior of the thermal massager 5 is provided with a heat mass transfer substance, and the heat from the transfer substance can be transmitted directionally to a massage applying end 200. In using the thermal massager 5, the planar direction in operating naprapathy is not limited. An opening end is provided with an opening 10 for the access of transfer substance, with the opening 10 being covered by a sealing cap 4 having a thermal expansion effect. When a main body 1 is operated for massaging, the opening 10 can be blocked effectively at any operating angle, allowing two axial ends of the main body 1 to be replaced for use selectively, so as to increase the massaging function. The thermal massager 5 is also provided with a sheath unit 3 having a heat resistant function. The sheath unit 3 can be covered replaceably on the top end and bottom end of the main body 1, depending on the state of use.

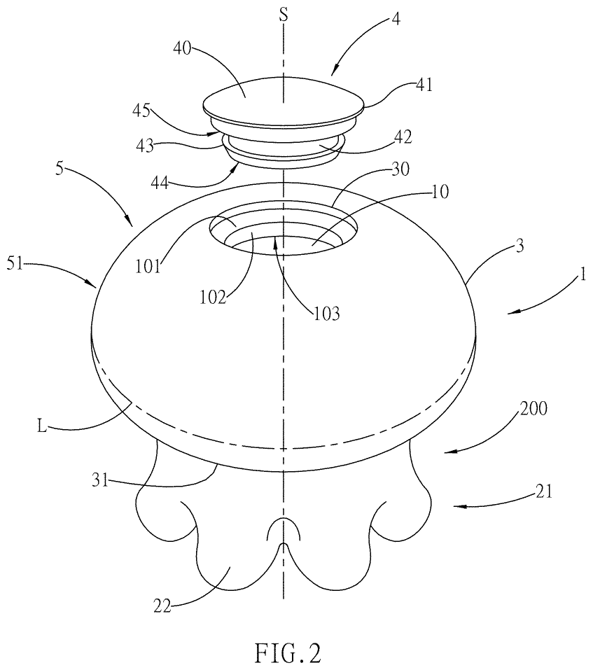

According to the angles shown in FIG. 1 and FIG. 2, the thermal massager 5 comprises a main body 1 having an axis S. A lower part of the main body 1 is coaxially connected to a massage applying end 200. The main body 1 is a shell unit and can be made of ceramic. An interior of the main body 1 is an inner chamber 11 which is connected through the opening 10 at the apex.

The contour of the main body 1 is a sphere and is provided with a three-dimensional curve, like two opposite conjugate curves which surround and rotate against the axis S to form the symmetric sphere. When a user chooses any end to hold for massaging, the planar direction in which the massage applying end 200 applies will not be limited.

In FIG. 1, the massage applying end 200 implements on a point-pressing end 21 which is formed by plural shell-like lumpy heads 22 which surround the axis S radially. An upper half of the main body 1 is an outer profile of the opening end of the opening 10, and is sheathed with a sheath unit 3 which is elastic, indented and heat resistant. A provided lower round opening 31 is contracted, and an inner surface thereof will be tightly combined on the outer surface of the opening end of the main body 1 when the sheath unit 3 is sheathed on the opening end. On the other hand, the sheath unit 3 can be also adhered on the outer surface of the main body 1. An apex of the sheath unit 3 is provided with a yielder 30 with a diameter larger than that of the opening 10, and the center of the yielder 30 is overlapped with the center of the opening 10.

The sealing cap 4 is provided with the thermal expansion effect, and a radial expansion stress can be at least acquired when the sealing cap 4 is heated, which tightly expands and presses to seal the opening 10. The sealing cap 4 is made of a polymeric plasticized material having a high thermal expansion coefficient. The thermal expansion coefficient is at least higher than that of the structural material of the opening 10. The opening 10 is integrally formed with the main body 1 and is made of ceramic mineral.

A top end of the sealing cap 4 is a disk-shaped outer cover plate 40, a periphery of the sealing cap 4 is a radial edge 41 which is pulled and buckled by fingers, a lower end of the sealing cap 4 is annularly provided with a barrel 44, and an upper side and a lower side of the outer circumference of the barrel 44 are formed respectively with a buckle lip 43 and a depressed torus 45.

The sheath unit 3 is elastic, and after being sheathed on the outer surface of the main body 1, the lower round opening 31 can be contracted at a level of waist, with the resulted binding function being able to stably combine the sheath unit 3 on the outer surface of the main body 1.

Referring to FIG. 2, the center of the yielder 30 is overlapped with the center of the opening 10, and the sheath unit 3 is sheathed on the opening end of the main body 1 to form a holding end 51. The sheath unit 3 is heat resistant and facilitates a user to grab with a hand by obtaining a friction force. After sheathing the sheath unit 3, the height of the lower round opening 31 is beyond a latitudinal center line L of the main body 1, allowing the sheath unit 3 to contract and bind the main body 1, so that a tight attaching force can be obtained between the sheath unit 3 and the main body 1 when the holding end 51 is operated. In addition, the force acted by the palm can be transmitted directly to the main body 1 through the fixed sheath unit 3, and is acted onto the massage applying end 200 indirectly.

The main body 1 is a sphere which is formed by the rotation and surrounding of the conjugated curves. When the main body 1 is used, there is not limitation to the planar direction for the massage applying end 200 combined at one end. In addition, after the sealing cap 4 is covered on the opening 10, the outer surface of the sealing cap 4 will not be exposed out of the sheath unit 3.

In the drawing, a point-pressing end 21 acts as the massage applying end 200. The point-pressing end 21 is formed by plural shell-like lumpy heads 22 which distribute annularly on a plane against the axis S.

A surface of the point-pressing end 21 is at least a smooth surface which is coated with enamel, and can be provided with an anion emissive material or a far-infrared transfer material to assist in exciting the cell molecules in the skin.

An upper end of the sealing cap 4 is a disk-shaped outer cover plate 40 which movably covers the opening 10 against the axis S, wherein the yielder 30 provided by the sheath unit 3 provides for access of the sealing cap 4.

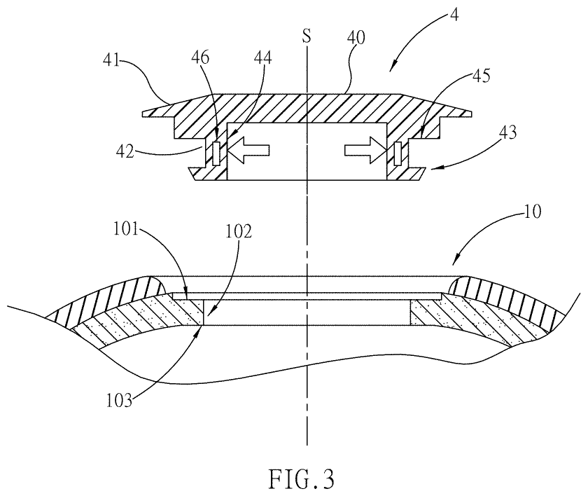

Referring to FIG. 3, an upper end of the opening 10 is a round-shaped flat stage 101 which is vertically connected to a latching ring 102. A lower end of the latching ring 102 is reversely connected to a latching edge 103 opposite the flat stage 101, forming a U-shaped cross section to the rim of the opening 10. In addition, an outer circumference of the barrel 44 of the sealing cap 4 is radially concaved with an inner annular slot 42 which is also a U-shaped cross section corresponding to the cross section of the opening 10. A side to the slot on an upper end of the inner annular slot 42 is a depressed torus 45, and a lower end is a buckle lip 43 with a diameter smaller than that of the depressed torus 45. The result of the sealing cap 4 covering the opening 10 is that the buckle lip 43 can reversely buckle the latching edge 103 on the lower end of the opening 10. The inner annular slot 42 can be coaxially sheathed on the latching ring 102 of the opening 10, and the depressed torus 45 can be pressed on the flat stage 101 of the opening 10.

An outer end on an upper part of the sealing cap 4 is a disk-shaped outer cover plate 40, a periphery is a radial edge 41 which can be lifted up by fingers and can be buckled by fingernails to take out the sealing cap 4. A lower end of the radial edge 41 is coaxially connected to a barrel 44, an outer circumference of the barrel 44 is concaved with an inner annular slot 42, the entire sealing cap 4 is integrally formed by a same material, and that material is a plasticized material which can be expanded by heat.

Furthermore, the barrel 44 can be radially provided with a loop-like thermal expandable element 46 which can be bulged outward by heat. The thermal expandable element 46 can be made of a thermal expandable metal or a memory metal. Under normal temperature, the diameter of the barrel 44 is unchanged, and will be expanded after heating, which drives the circumference at a bottom of the inner annular slot 42 to expand outward radially. By the assistance of the thermal expandable element 46, the sealing cap 4 can be conveniently made of an ordinary elastic plasticized material. In addition, by the mechanical expansion action of the thermal expandable element 46, a radial expansion force for closing can be more explicitly generated to the latching ring 102 (as shown in FIG. 2).

The sealing cap 4 can spring back; at least when the buckle lip 43 accesses to perform the covering operation, the sealing cap 4 can be elastically deformed by an external force, and the best scenario is that the user can conveniently pick up and take the buckle lip 43 by fingers from the radial edge 41 to disengage the latching edge 103, thereby driving the entire sealing cap 4 to escape from the opening 10.

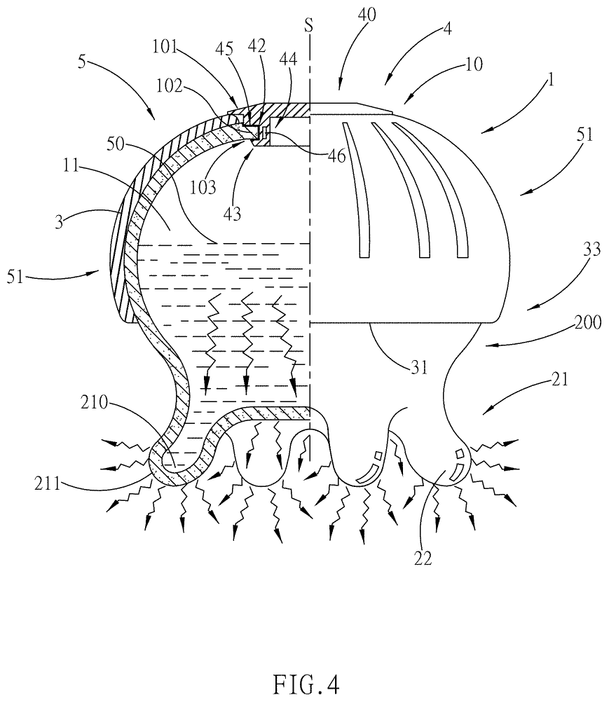

Referring to FIG. 4, an end of the main body 1 of the thermal massager 5 is a round-head-shaped opening end. The outer surface of that end is assembled with the sheath unit 3 to form a holding end 51. An interior of the main body 1 is formed with an inner chamber 11, and a top end of the inner chamber 11 is covered or opened by the sealing cap 4. A lower end of the main body 1 is a massage applying end 200 which is a point-pressing end 21 having the shell-like lumpy heads 22. A closure round head 211 of the lumpy head 22 faces downward, and an interior of the closure round head 211 is formed with an inner culvert hole 210 which is connected with the inner chamber 11 of the main body 1.

When an interior of the inner chamber 11 is emplaced with the transfer substance 50, the heat mass contained in the transfer substance 50 will create a heat balance function. First, the heat mass will be released on the entire outer surface of the main body 1. As the transfer substance 50 is filled into the holding space of the inner culvert holes 210, the heat mass will be also released at the massage applying end 200, and a three-dimensional heat radiation wave will be released on the outer surface of each shell-like lumpy head 22, wherein the transfer substance 50 is a material that can absorb and release heat, such as liquid water which is filled into the inner chamber 11 after being heated up outside the thermal massager 5 in advance.

The closure round head 211 is provided with a smooth surface and therefore is provided with a higher refractivity, allowing the internal heat radiation wave to emit from the closure round head 211. Under a microscopic view, the unit area for emitting the heat radiation wave is smaller for the smooth surface of the closure round head 21, in terms of the total area and the rough surface. However, due to the smooth surface, the heat radiation wave can be refracted easily. In addition, as the smooth surface is higher in density, the heat mass transmission efficiency is also higher. On the outer surface of another end of the main body 1, there is a sheath unit 3 to form a holding end 51. The heat resistant function of the sheath unit 3 allows the heat wave of the transfer substance 50 inside the inner chamber 11 to be not easily released from the area covered by the sheath unit 3. Therefore, the heat release path of the transfer substance 50 will be pointed to the massage applying end 200 according to the heat balance function, so that the heat mass of the transfer substance 50 can be completely pointed to the skin of the massaged person.

Being defined by the axis S, another opening end opposite the massage applying end 200 is in a shape of round head, with the outer surface forming a holding end 51 after being sheathed by the sheath unit 3. Therefore, the palm of a massagist can grab the holding end 51 strongly, and the force exerted by the palm will act onto the main body 1 through the sheath unit 3, and then is transmitted to the massage applying end 200 from the main body 1.

The main body 1, including the massage applying end 200, can be made of ceramic which is provided with a lower heat conduction rate and can isolate more heat relatively. Besides, a ceramic product is harder, and its outer surface can be coated with enamel, allowing the outer surface of the massage applying end 200 to be smoother.

The inner surface of the inner chamber 11 is made of ceramic and should be coated with a waterproofing material. In addition, the outer surface of the point-pressing end 21 is at least a smooth surface which is coated with enamel.

After the inner annular slot 42 provided by the sealing cap 4 is latched and plugged into the opening 10 for combination, the formed U-shaped blocking structure with many bends will prevent the fluid transfer substance 50 from seeping out of the opening 10 easily.

After the sealing cap 4 is subjected to the heat mass of transfer substance 50, a thermal expansion action will be formed. Wherein, depending on the ratio of the heated area, the largest expansion occurs at the outer cover plate 40. According to the radial tension, the outer cover plate 40 will assist the barrel 44 to result in the radial expansion, and the force of that radial expansion will be transmitted to the inner annular slot 42 to press the inner circumference of the latching ring 102, forming a mechanical action to block the opening 10.

Moreover, the thermal expandable element 46 disposed at the radial loop of the barrel 44 can be made of memory metal or thermal expandable metal. After the thermal expandable element 46 is injected with the heat mass, a radial expansion can be resulted to expand the diameter thereof, which in turn presses the surface on the bottom of the inner annular slot 42 to result in a radial pressure. The radial pressure presses the inner surface of the latching ring 102 opposite the opening 10, achieving the mechanical pressure binding.

When the temperature of transfer substance 50 drops gradually with time after heat exchange, the thermal expandable element 46 will also release temperature accordingly. Therefore, due to the temperature drop, the electronic structure in the tissue of the thermal expandable element 46 is changed, restoring to the original pattern with a smaller diameter, which also links the inner annular slot 42 to withdraw the pressure to the latching ring 102.

Regarding the leak-tight function of the opening 10, in addition to the radial operation of the thermal expandable element 46, the sealing cap 4 is further provided with an axial sealing function. When the thermal massager 5 is used for massaging, according to the time of heat exchange, the temperature of transfer substance 50 decreases gradually with time, whereas the internal pressure in the inner chamber 11 decreases simultaneously. This low pressure will press the depressed torus 45 of the sealing cap 4 toward the direction opposite the flat stage 101 of the opening 10. On the contrary, in the beginning where the inner chamber 11 is filled with high-temperature liquid, the inner space of the inner chamber 11 will result in a positive expansion pressure to push the inner surface of the outer cover plate 40 of the sealing cap 4. The outer cover plate 40 will then link the buckle lip 43 to press up the latching edge 103 that is disposed below the opening 10 through the barrel 44, resulting in a pressure binding. Hence, an axial and radial blocking force can all be obtained no matter the temperature is high or low. On the other hand, under the critical condition that the inner pressure is balanced with the outer pressure, the leak-tight function can be achieved by the tight attachment of the inner annular slot 42 to the surface of the latching ring 102, as there is no interference of external force.

By the structure, upon filling the transfer substance 50 into the inner chamber 11, the inner space of the inner chamber 11 will result in the expansion pressure to press the sealing cap 4, allowing the buckle lip 43 to seal the latching edge 103 of the opening 10. When temperature drops with time in operating the massage, the inner pressure of the inner chamber 11 decrease to a negative pressure state, which links the sealing cap 4 to drive the depressed torus 45 to press the flat stage 101 of the opening 10. At the critical condition that the pressure is balanced, the inner annular slot 42 can be kept to tightly bind the latching ring 102, so that in the entire process of operating the massage, the complete leak-tight sealing effect can be achieved, preventing the liquid transfer substance 50 from seeping out.

For the size of cross section formed by connecting the abovementioned inner annular slot 42, buckle lip 43, and depressed torus 45, under the condition that the sealing cap 4 is elastic, the width of the inner annular slot 42 can be smaller than the distance between the flat stage 101 and the latching edge 103, and the diameter can be a little larger than that of the latching ring 102. In addition, the shape of cross section formed by connecting the inner annular slot 42, the buckle lip 43, and the depressed torus 45, is in the same U-shape as that formed by connecting the flat stage 101, the latching ring 102, and the latching edge 103 of the opening 10. By the bending of the U-shaped cross section, a good leak-tight function can be achieved.

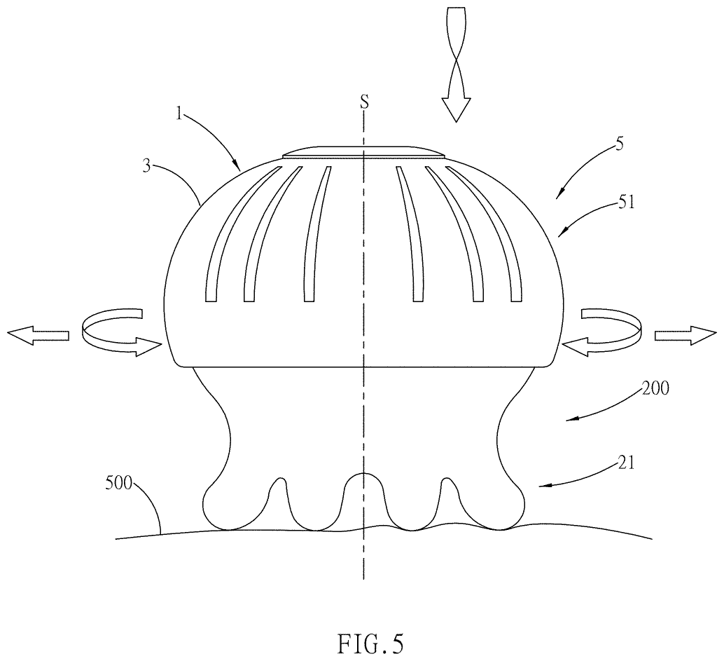

Referring to FIG. 5, as the profile of the main body 1 in the present invention is like a sphere formed by the surrounding of the conjugate curve against the central axis, after the upper end of the part to be held by the palm is covered by the sheath unit 3, a round-head-shaped holding end 51 is formed. In addition, the bottom massage applying end 200 is also distributed on and surrounds a constant height surface annularly against the axis S, so that the operating plane of the massage applying end 200 will not be limited in direction while doing massage, and can easily rotate clockwise and counterclockwise in-site or push back and forth in any direction. Furthermore, the massage applying end 200 can push downward and rotate toward the skin surface 500. As the upper end of the massage applying end 200 is a round-head design, the massage applying end 200 can be held easily at any planar angle, and the direction in exerting the force on the plane is not limited as well, which even facilitates the usage by the massagist at any naprapathy skill, and also facilitates a patient to do the naprapathy by himself or herself without the limitation to direction.

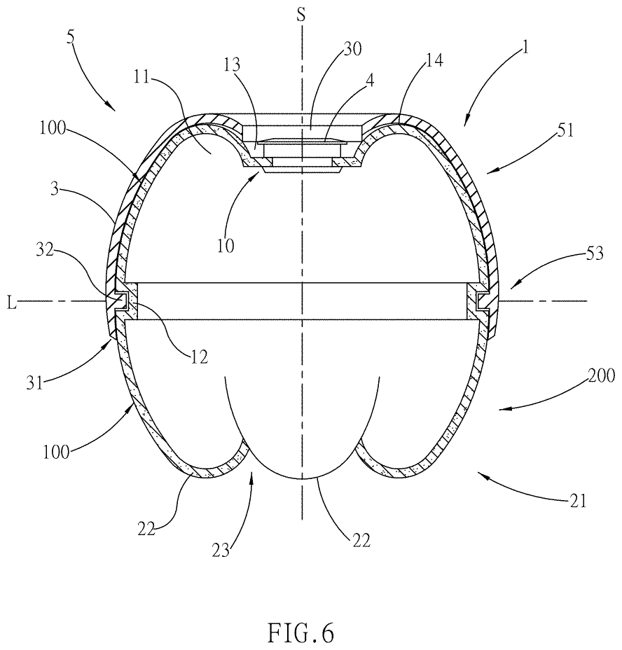

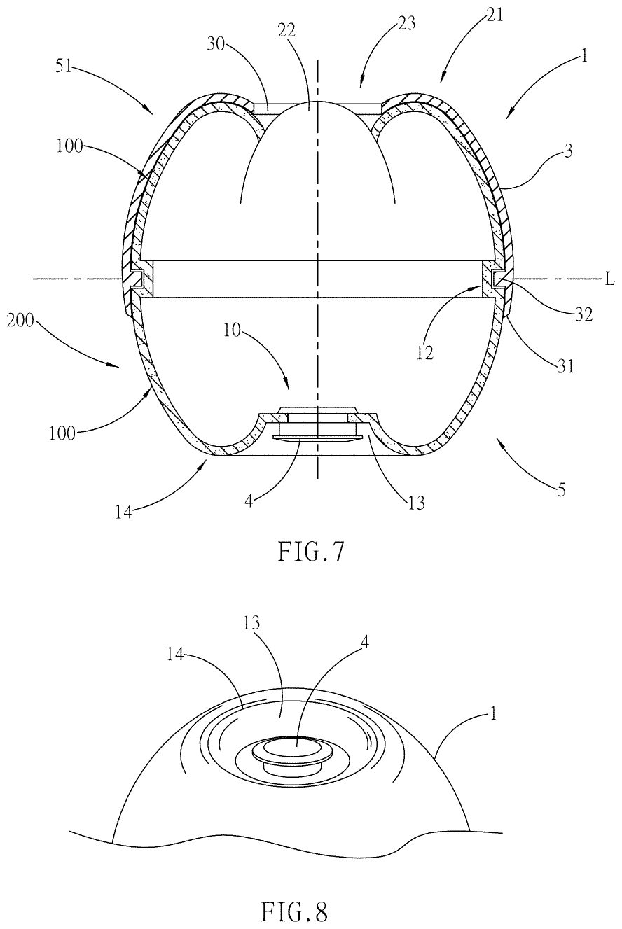

Referring to FIG. 6 and FIG. 7, by the structure of the main body 1, each end can be selected as the massage applying end 200 or the holding end 51, and the provided sheath unit 3 with the heat resistant function can be also replaced and sheathed on one end accordingly. The end of the main body 1 covered by the sheath unit 3 is defined as the holding end 51, whereas the exposed end is defined as the massage applying end 200.

The opening 10 provided by the main body 1 can be sealed effectively by the sealing cap 4 having the thermal expansion effect. Therefore, when the main body 1 is being used in operating the massage, the posture at the angular position can be reversed, and the annular structure of the provided annular scrape opening 14 can be utilized to form another massage applying end 200 for scraping and doing physical therapy, thereby increasing the function of use of the main body 1.

In implementing the present invention, the massager surrounds conjugably against the axis S to form the main body 1 with the inner chamber 11, and when the massage applying end 200 is exposed, the other end opposite the massage applying end 200 against the axis S can be a holding end 51.

In implementing the main body 1, the waist part is expanded outward with a belly 53. The latitudinal center line L of the belly 53 is concaved with a concaved annular groove 12, so that after binding the sheath unit 3, an inner rib ring 32 at the corresponding position can be bound and latched. According to the definition of the concaved annular groove 12, the sheath unit 3 can be covered on the upper or lower end of the main body 1; therefore, the point-pressing end 21 of the massage applying end 200 is exposed for point-press massage or the annular scrape opening 14 is exposed for scraping after replacing the sheath unit 3.

The implementation of the massage apply end 200 acts as the basis of massage for plural point-pressing ends 21 that are arranged annularly. The entire sheath unit 3 is covered on the opening end to form a holding end 51; whereas, the point-pressing ends 21 of the massage applying end 200 provide for point-pressing massage on the skin.

The fundamental structure of the thermal massager 5 is a shell burned from a ceramic material, the outer shape is annular symmetric to the axis S, and the lower end is the massage applying end 200 formed by the shell-like lumpy heads 22. The outer curve 100 on the surface of the massager is symmetric to the outer curve 100 on the other opening end of the main body 1 against the latitudinal center line L. The waist surface of the main body 1 is a protruded belly 53. A center of the apex on the opening end is axially concaved with a pedicle slot 13, and a bottom of the pedicle slot 13 is provided with an opening 10. The sealing cap 4 accesses from the yielder 30 of the sheath unit 3 to cover the opening 10; whereas, the outer end surface of the point-pressing end 21 is concaved inward with a cavity space 23 opposite the pedicle slot 13, facing exactly the axis S.

At the height of the latitudinal center line L, the main body 1 is provided with a concaved annular groove 12, and an inner surface of the sheath unit 3 is annularly provided with the opposite inner rib ring 32. By latching the inner rib ring 32 into the concaved annular groove 12, the sheath unit 3, including a lower round opening 31, can be covered on the outer surface of the main body 1 stably.

Referring to FIG. 7 and FIG. 8, in the present invention, the sheath unit 3 is designed to be replaceably covered on two ends of the main body 1, providing for the multifunctional use.

Opposite the point-pressing end 21, the opening end surface of the main body 1 is axially concaved with the pedicle slot 13. The annular opening of the pedicle slot 13 intersects with the curve to form the annular scrape opening 14; the surface of the annular scrape opening 14 and the surface of the shell-like lumpy head 22 are all smooth that they can be used to scrape along an arc line for operating massage.

The replacement of the sheath unit 3 requires the entire massage applying end 200 having the shell-like lumpy heads 22 to form the outermost curvature, and the latitudinal center line L to be symmetric to the other end of the main body 1. Then, the part formed by the shell-like lumpy heads 22 can be also covered by the sheath unit 3, thereby forming the holding end 51 on the other end for replacement.

The inner surface of the sheath unit 3 can cover all of the shell-like lumpy heads 22 to expose the annular scrape opening 14, providing another massage applying end 200 for scraping and doing physical therapy.

The opening 10 can be blocked effectively by the sealing cap 4 with the thermal expansion effect. Then, the opening 10 can face downward, allowing the surface of the annular scrape opening 10 to apply massage downward. In the process, the opening 10 is leak-tight.

The annular scrape opening 14 forms a pressing structure with an arc-shaped opening to increase the massage function; especially in massaging a larger limb of a human body, such as leg or back, the annular scrape opening 14 can scrape and massage within the contact range of arc length for scraping and doing physical therapy.

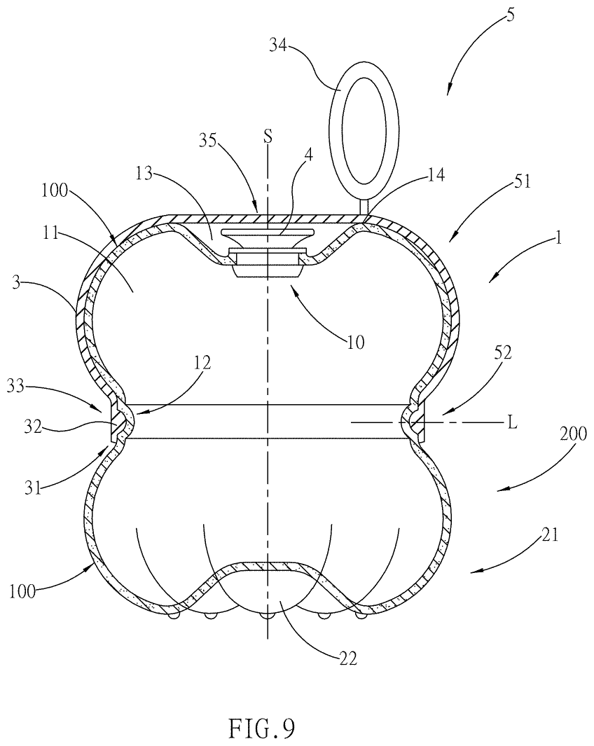

Referring to FIG. 9, to facilitate holding and grabbing by a hand for massaging, the location of the latitudinal center line L of the thermal massager 5 is shrunk to provide a contracted waist 52, the provided sheath unit 3 forms a contraction flap 33, and the inner side of the contraction flap 33 faces exactly the latitudinal center line L for contraction. The provided lower round opening 31 goes downward beyond the latitudinal center line L and the two axial ends of the main body 1. As the abovementioned structure, the sheath unit 3 is covered replaceably, and the outer surfaces on two ends are provided respectively with an outer curve 100 which separates by the latitudinal center line L to form the curves that are symmetric vertically.

The sheath unit 3 can be covered on the outer surface of the opening end opposite the point-pressing end 21 of the main body 1, forming a holding end 51. The contraction flap 33 is sheathed on the latitudinal center line L, the sealing cap 4 is also sealed on the opening 10, and the concaving of the pedicle slot 13 enables the sealing cap 4 to descent beyond the annular scrape opening 14. On the other hand, another method is that the sheath unit 3 can be formed with a dome 35 at the annular scrape opening 14 to enclose the sealing cap 4 simultaneously, which increase the heat insulation effect.

The sheath unit 3 and the main body 1 are provided at the contracted waist 52 with the concaved annular groove 12 and the inner rib ring 32. The inner rib ring 32 is similarly latched into the concaved annular groove 12, allowing the sheath unit 3 to be even more stable after combination. According to this implementation, by the grabbing of the formed holding end 51, the point-pressing end 21 with the shell-like lumpy heads 22 is provided to operate as point-like massaging, wherein the center line of the contracted waist 52 is the latitudinal center line L.

The outer axial end of the sheath unit 3 can be connected with a finger ring 34. The finger ring 34 can provide for carrying or for holding more stably by the transfixing of a finger in operating massage to avoid dropping. In addition, by the finger ring 34, the direction in operating massage can be assigned.

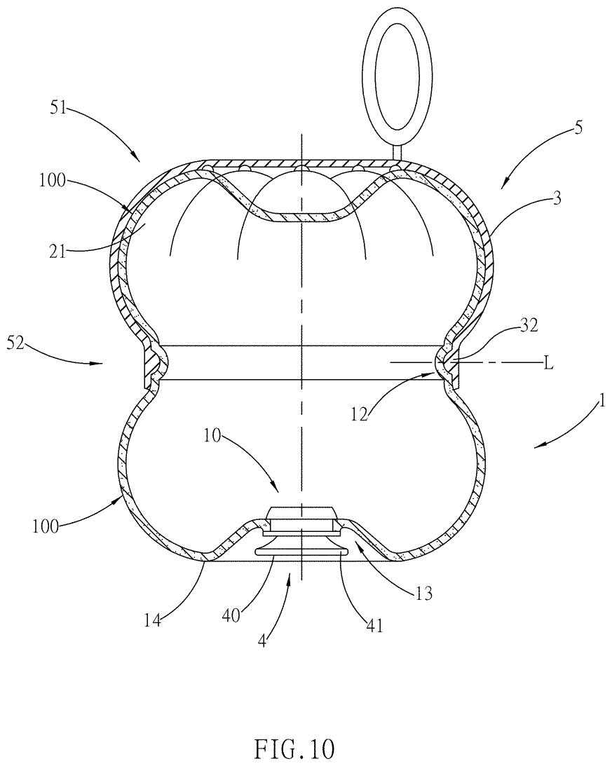

Referring to FIG. 10, the sheath unit 3 is covered replaceably to form the multifunctional use. The waist of the main body 1 is provided with the contracted waist 52. By the shrinking of the contracted waist 52 and the needed structure for replacement, the sheath unit 3 is replaceably covered on the outer surface of the point-pressing end 21 reversely, thereby forming another holding end 51.

The main body 1 is annularly provided with the concaved annular groove 12 along the height of the latitudinal center line L, and opposite the concaved annular groove 12, the inner surface of the sheath unit 3 is provided correspondingly with the inner rib ring 32 which snaps inward.

The pedicle slot 13 disposed on one end of the main body 1 is concaved. Whereas, the outer rim is formed with the annular scrape opening 14. The sealing cap 4 seals the opening 10, and the provided outer cover plate 40 submerges into the annular scrape opening 14; therefore, it will not affect the pushing of the annular scrape opening 14 in doing massage.

By the replacement of the abovementioned sheath unit 3, two ends of the main body 1 can be used respectively, thereby increasing the structural function of massage.

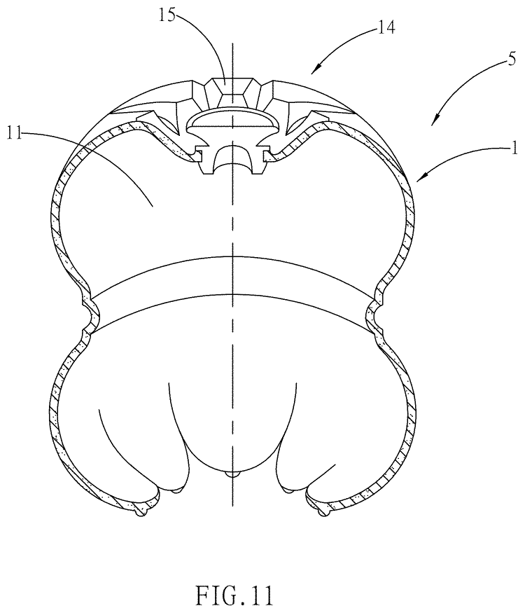

Referring to FIG. 11, the annular scrape opening 14 provided by the main body 1 of the thermal massager 5 is an annular opening as shown above. In addition, the annular scrape opening 14 can be even provided with plural annular bumps 15 on the circumference. By the protrusion of every annular bump 15, the massage structure in the shape of annular blocks can be provided for use in various naprapathy. Especially, by the annular bumps 15, an explicit scraping effect can be resulted. Furthermore, the inner chamber 11 accumulates the warm transfer substances. Accordingly, by the assistance of temperature from the transfer substances, the physical therapy of scraping can achieve the outcome of forming scraping marks.

The present invention discloses primarily the main body with the central axis. The outer profile of the main body facilitates holding by a palm, and by the heat resistant function of the sheath unit, the outer surface of the main body will transmit the heat energy of transfer substances stored in the main body downward to the massage applying end directionally. In addition, by the heat loss from operation, the heat balance inside the main body can be acquired rapidly. As the sheath unit is elastic, it can facilitate the operator to hold. By the sheathing structure above and below the sheath unit, the function of use can be increased. Furthermore, by the sealing cap with the thermal expansion effect, the opening can be sealed more effectively due to the thermal action of the transfer substances.

With the design of many kinds of improvements, the present invention is an explicitly improved design among similar inventions, such as a massager with interior hot water being used as a heat mass transfer substance.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A thermal transfer massager, comprising
a shell-like heat conductible main body having an axis, with that an interior of the main body is a waterproofed inner chamber, an outer axial end is an opening end, the opening end is coaxially provided with an opening which is connected to the inner chamber, the other end is combined with a point-pressing end which is formed by plural shell-like lumpy heads arranged annularly and radially, and an interior of each shell-like lumpy head is connected to the inner chamber;
a sheath unit, which is covered obediently on the opening end of the opening of the main body;
a disk-shaped sealing cap which is deformed elastically and is provided with a radial thermal expansion effect, with that the sealing cap provides for sealing the opening, and the thermal expansion coefficient of the sealing cap is larger than that of the opening.

2. The thermal transfer massager according to claim 1, wherein the main body is a ceramic shell-like body formed integrally.

3. The thermal transfer massager according to claim 1, wherein a top end of the sealing cap is a disk-shaped outer cover plate, a periphery of the outer cover plate is a radial edge to be pulled and buckled by fingers, a lower end is annularly provided with a barrel, and an upper and lower side of outer circumference of the barrel are provided respectively with a buckle lip and a depressed torus.

4. The thermal transfer massager according to claim 1, wherein the outer end of the opening is provided with a flat stage which is vertically connected to a latching ring, a lower end of the latching ring is reversely connected to a latching edge to form a U-shaped cross section, the flat stage provides for the depressed torus of the sealing cap to press axially, the latching ring provides for an inner annular slot of the sealing cap to expand radially, and the latching edge provides for the buckle lip of the sealing cap to buckle reversely.

5. The thermal transfer massager according to claim 1, wherein the barrel provided by the sealing cap is combined with a thermal expandable element which moves radially and expands the inner annular slot.

6. The thermal transfer massager according to claim 1, wherein a latitudinal center line of the main body is annularly concaved with a concaved annular groove, and an interior of the sheath unit is provided on a linear position opposite the concaved annular groove with an inner rib ring which is latched into the concaved annular groove.

7. The thermal transfer massager according to claim 1, wherein the surfaces of the main body and the shell-like lumpy heads are provided with an anion emissive material.

8. The thermal transfer massager according to claim 1, wherein the surfaces of the main body and the shell-like lumpy heads are provided with a far-infrared transfer material.

9. The thermal transfer massager according to claim 1, wherein the sealing cap is made of a polymeric plasticized material with high thermal expansion coefficient.

10. A transfer replacement structure of a thermal transfer massager, comprising
a shell-like heat conductible main body with an axis, with that the main body is held by a palm, an outer curve is annularly symmetric to the axis, an interior of the main body is a waterproofed inner chamber, an axial end of the main body is an opening end which is coaxially provided with an opening to connect the inner chamber, the other end is combined with a point-pressing end formed by plural annularly and radially arranged shell-like lumpy heads, an interior of each shell-like lumpy head is connected to the inner chamber, the point-pressing end is covered by the outer curve, a latitudinal center line of which is symmetric to the other opening end of the main body, an end surface of the opening end is coaxially concaved with a pedicle slot, an outer rim of the pedicle slot is formed with an annular scrape opening, a bottom of the pedicle slot is opened with the opening, an outer end surface of the point-pressing end connected by the main body is concaved with a cavity space along the axis, and the latitudinal center line on the surface of a waist is radially concaved with a concaved annular groove;
a disk-shaped sealing cap having a radial thermal expansion effect, which provides for sealing the opening; and
a heat-resistant sheath unit, which is replaceably covered on two ends of the main body, with that an inner surface of the sheath unit is provided with an inner rib ring corresponding to the height at which the concaved annular groove is sheathed.

11. The transfer replacement structure of a thermal transfer massager, according to claim 10, wherein the sheath unit is replaceably covered on two ends of the main body, and the provided lower round opening goes beyond the latitudinal center line.

12. The transfer replacement structure of a thermal transfer massager, according to claim 10, wherein the waist of the main body is shrunk with a contracted waist.

13. The transfer replacement structure of a thermal transfer massager, according to claim 10, wherein the waist of the main body is bulged outward with a belly.

14. The transfer replacement structure of a thermal transfer massager, according to claim 10, wherein the main body is shell-like body formed integrally by ceramic, and the surfaces of the annular scrape opening and the shell-like lumpy heads are smooth.

15. The transfer replacement structure of a thermal transfer massager, according to claim 10, wherein the surfaces of the annular scrape opening and the shell-like lumpy heads are distributed with an energy emissive material.

16. The transfer replacement structure of a thermal transfer massager, according to claim 10, wherein the surfaces of the annular scrape opening and the shell-like lumpy heads are distributed with a far-infrared transfer material.

17. The transfer replacement structure of a thermal transfer massager, according to claim 10, wherein the annular surface of the annular scrape opening is provided with plural annular bumps which are arranged annularly.

18. The transfer replacement structure of a thermal transfer massager, according to claim 10, wherein an outer end of the opening is provided with a flat stage which is vertically connected to a latching ring, a lower end of the latching ring is reversely connected to a latching edge to form a U-shaped cross section, the flat stage provides for the depressed torus of the sealing cap to press axially, the latching ring provides for an inner annular slot of the sealing cap to expand radially, and the latching edge provides for a buckle lip of the sealing cap to buckle reversely.

19. The transfer replacement structure of a thermal transfer massager, according to claim 10, wherein the barrel of the sealing cap is combined with a thermal expandable element which moves radially.

20. The transfer replacement structure of a thermal transfer massager, according to claim 10, wherein the sealing cap is made of a polymeric plasticized material with high thermal expansion coefficient.
